(19) United States
(12) Patent Application Publication
(10) Pub. No.: US 2004/0178796 A1
(43) Pub. Date: Sep. 16, 2004

(54) Magnetic resonance device with a basic field magnet and at least one gradient coil

(76) Inventor: Oliver Heid, Gunzenhausen (DE)

Correspondence Address: SCHIFF HARDIN, LLP, PATENT DEPARTMENT, 6600 SEARS TOWER, CHICAGO, IL, 60606-6473, US

(21) Appl. No.: 10/796,221

(22) Filed: Mar. 9, 2004

(30) Foreign Application Priority Data
Mar. 10, 2003 (DE) 103 10 356.2

(51) Int. Cl. G01V 3/00

(52) U.S. Cl. 324/334

(57) ABSTRACT

In a magnetic resonance device a basic field magnet generates a basic magnetic field that exhibits, within an imaging volume of the magnetic resonance device, a main component oriented in a predeterminable direction. At least one gradient coil is arranged in a region of the gradient magnetic field in which the basic magnetic field exhibits at least one secondary component perpendicular to the main component. Conductors of the gradient coil are arranged such that, given flow of an electrical current in the conductors, a turning moment operating via the main component and affecting a part of the gradient coil is at least partially compensated by a turning moment acting via the secondary component.

### BACKGROUND

The invention concerns a magnetic resonance device.

Magnetic resonance technology is a known technology to, among other things, acquire images of the inside of a body of an examination subject. In a magnetic resonance device, rapidly switched gradient fields that are generated by a gradient coil system are thereby superimposed on a static homogenous basic magnetic field that is generated by a basic field magnet. The magnetic resonance device also comprises a radio-frequency system that radiates radio-frequency signals into the examination subject to excite magnetic resonance signals, and acquires the excited magnetic resonance signals on the basis of which magnetic resonance images are created.

To generate the gradient field, corresponding currents are adjusted in the gradient coil. The amplitudes of the required currents thereby amount to more than 100 A. The current rise and fall rates amount to more than 100 kA/s. An existing basic magnetic field affects these temporally changing currents in the gradient coil on the order of 1 T Lorentz forces, that lead to oscillations of the gradient coil system. These oscillations are reproduced over various propagation paths at the surface of the magnetic resonance device. The mechanical oscillations are thereby transduced into sound vibrations that subsequently lead to an undesired noise. Furthermore, the Lorentz forces can also lead to an undesired rigid-body motion of the gradient coil system with regard to the rest of the magnetic resonance device.

A reduction in principle of oscillations of the gradient coil system via an active technique is specified in DE 44 32 747 A1. For this, a device comprising in particular electrostrictive elements is arranged in or on the gradient coil system. With this device, forces can be generated that counteract the oscillations of the gradient coil system such that a deformation of the gradient coil system is substantially prevented. However, this solution is cost-intensive, in particular due to the high expenditure in connection with the electrostrictive elements, their arrangement and their regulation.

A method to operate a magnetic resonance device is specified in DE 199 03 627 A1 in which forbidden frequency bands are defined around the resolution frequencies of a gradient coil system, and the gradient coil currents are controlled in the framework of pulse sequences such that they exhibit no spectral components within these forbidden frequency bands, such that an excitation of noise peaks is prevented. However, this solution also represents no general loophole, since it influences only the resolution frequency ranges.

Finally, a gradient coil system is known from DE 198 29 298 A1 with which only a part of the body of a patient, for example his head, can be imaged. The gradient coil system thereby comprises an asymmetrical gradient coil that is assembled with a turning moment-compensating conductor design.

### SUMMARY

It is an object to achieve an improved magnetic resonance device in which, among other things, a lower noise emission is achieved.

In a magnetic resonance device, a basic field magnet generates a basic magnetic field that exhibits, within an imaging volume of the magnetic resonance device, the main component oriented in a predeterminable direction. At least one gradient coil is arranged in a region of a gradient magnetic field in which the basic magnetic field exhibits at least one secondary component perpendicular to the main component. Conductors of the gradient coil are arranged such that, given flow of an electrical current in the conductors, a turning moment operating via the main component and effecting a part of the gradient coil is at least partially compensated by a turning moment acting via the secondary component.

### BRIEF DESCRIPTION OF THE DRAWINGS

FIG. 1 is a longitudinal section through a superconducting coil and a gradient coil of a magnetic resonance device; and

FIGS. 2, 3 and 4 show azimuthal and axial currents in a basic magnetic field with an axial main component and a radial secondary component.

### DESCRIPTION OF THE PREFERRED EMBODIMENT

For the purpose of promoting an understanding of the principles of the invention, reference will now be made to a preferred embodiment illustrated in the drawings and specific language will be used to describe the same. It will nevertheless be understood that no limitation of the scope of the invention is thereby intended, such alterations and further modifications in the illustrated device, and/or method, and such further applications of the principles of the invention as illustrated therein being contemplated as would normally occur now or in the future to one skilled in the art to which the invention relates.

The mechanical oscillation tendency of the gradient coil is directly reduced at the creation point via the compensation of bending moments that can be effected, whereby a high noise-reducing effect is achieved and limitations of previous solution approaches are overcome. The preferred embodiment is based on the realization that the basic magnetic field already exhibits a sufficiently large secondary component perpendicular to the main component in the region in which the conductors are typically arranged, and the secondary component can be used in connection with a corresponding conductor arrangement to compensate turning moments. In comparison to a comparable conventional gradient coil, the gradient coil provided thereby exhibits an inductivity increased by only a few percentage points, given otherwise identical properties.

In an advantageous embodiment, the gradient coil is a transversal gradient coil of a gradient coil system for a magnetic resonance device with a substantially cylindrical patient acceptance space. The design of the transversal gradient coil is particularly advantageous since the saddle-shaped coils of the transversal gradient coil through which current flows, in connection with the main component, provided turning moments that strain the gradient coil system to bending, and the rigidity of the gradient coil system with regard to the bending moments is comparably small such that large elastic deflections, and therewith noise, would be created without the embodiment disclosed. Moreover, the fundamental eigen frequency of the gradient coil system for the most part lies in the range of strong spectral components of the associated gradient coil current. Without the embodiment provided, the excitation of mechanical resonances thereby possible would lead to a repeated substantial noise increase. The forces of a longitudinal gradient coil occurring in connection with the main component substantially radially stress the gradient coil system. Due to the high rigidity of the gradient coil system with regard to such stresses, only comparably slight elastic deformations occur, such that the acoustic sound emission typically remains small. Moreover, all resonance frequencies for the most part lie sufficiently far above the largest part of the power spectrum of the associated gradient coil current. A lengthwise shearing force caused by the secondary component of the basic magnetic field can thereby be easily remedied via a suitable positioning of the conductor for a given basic field magnet.

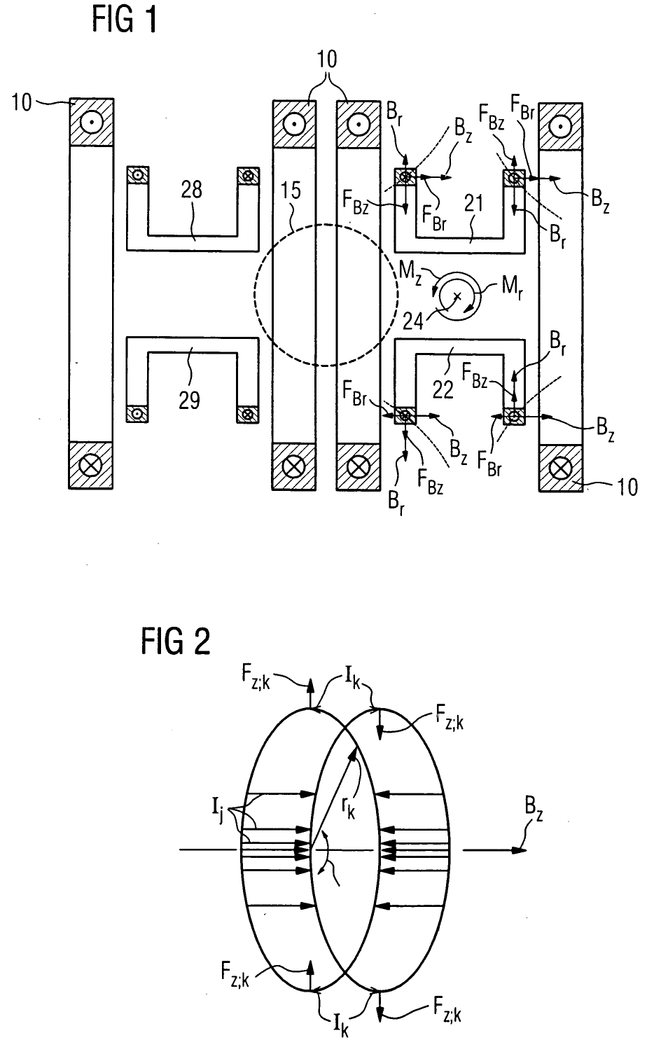

FIG. 1 shows, as an exemplary embodiment, a longitudinal section through a superconducting coil 10 of a basic field magnet and a transversal gradient coil of a magnetic resonance device with a tunnel-like patient acceptance space. For reasons of clarity, the superconducting coil 10 and the transversal gradient coil are shown cut free of the rest of the components of the magnetic resonance device. The remaining components comprise, for example, a helium vessel, cryoshield and a vacuum vessel of the basic field magnet, as well as further gradient coils, shielding coils, shim coils and an epoxy seal [encapsulation] of a gradient coil system, as well as a radio-frequency antenna system. Four annular windings of the superconducting coil 10 are exemplarily shown. The transversal gradient coil comprises a left and a right coil half with two saddle-shaped, opposing sub-coils 21 and 22 as well as 28 and 29 per coil half. Likewise, for reasons of clarity only one winding is exemplarily shown per sub-coil 21, 22, 28 and 29.

Given a corresponding current flow in the superconducting coil 10, the basic field magnet generates an optimally homogenous static basic magnetic field, at least within an imaging volume 15 in the direction of a cylinder main axis, that is created via a connection of the center points of the annular windings of the superconducting coil 10. The symbol [symbol] designates a current flow exiting from the drawing plane, and the symbol \mathring{x} designates a current flow entering into the drawing plane. In the region in which the windings of the sub-coils 21, 22, 28 and 29 are arranged, the basic magnetic field is no longer homogenous and also comprises, in addition to a main component B_{z} in the direction of the cylinder main axis, a radially-directed secondary component Bᵣ.

Due to the main component B_{z} of the basic magnetic field, in the region of the slice plane of FIG. 1 the forces designated with F_{Bz} (that effect a turning moment M_{z} with regard to a focal point 24 of the right coil half) act on the sub-coils 21 and 22 of the right coil half. For determination of the forces F_{Bz} according to direction, a current flow is thereby accepted in the sub-coils 21 and 22 that is established by the symbols [symbol] and \mathring{x} explained in the superconducting coil 10. According to the preferred embodiment, the conductors of the sub-coils 21 and 22 are furthermore arranged such that, due to the radial secondary component Bᵣ of the basic magnetic field, forces F_{Br} (that, with regard to the focal point 24, generate a turning moment Mᵣ that optimally, completely counteracts the turning moment M_{z}) act in the region of the slice plane on the sub-coils 21 and 22 through which current flows. A turning moment compensation is therewith achieved for the coil halves arranged, for example, in a hollow-cylindrical cast-resin seal. The same correspondingly holds true for the sub-coils 28 and 29.

The preceding specification is correspondingly applicable to an actively-shielded gradient coil that comprises a primary coil and a shielding coil, whereby the further conductors of the shielding coil are to be considered in addition to the conductors of the primary coil as the (as it were) actual gradient coil. The sums of turning moments and forces originating from both the primary coil and the shielding coil are thereby to be considered for the compensation.

The preceding specified conductor arrangement of the gradient coil originates from a fixed predetermined curve of the secondary component Bᵣ due to a previously implemented basic field magnet design. In other embodiments, the naturally basic field magnet and gradient coil can be designed tuned to one another, such that the curve of the secondary component Bᵣ can be controlled to a certain extent via the design of the basic field magnet.

Specified in the following is a procedure to determine the turning moment-compensating conductor arrangement of the gradient coil. For this, it is advisable for the subsequent considerations to separate the transversal gradient coil in rings whose currents respectively possess purely azimuthal and purely axial components. Since the transversal gradient coils generate a transversal gradient perpendicular to the cylinder main axis, the azimuthal current Iₖ in each ring is substantially proportional to the cosine of the azimuthal angle φ and the axial currents Iⱼ are substantially proportional to the sine of the azimuthal angle φ. The forces considered in the following are thereby substantially caused by the azimuthal currents Iₖ. If a ring k possesses the radius rₖ and the axial position zₖ, the force F_{z;k} caused in the gradient direction by the azimuthal current Iₖ and the main component B_{z}(rₖ;zₖ) of the basic magnetic field is:

$${F}_{z ; k} = {I}_{k} {r}_{k} {B}_{z} {\int }_{0}^{2 π} {cos}^{2} ϕ ⅆ ϕ = π {I}_{k} {r}_{k} {B}_{z}$$

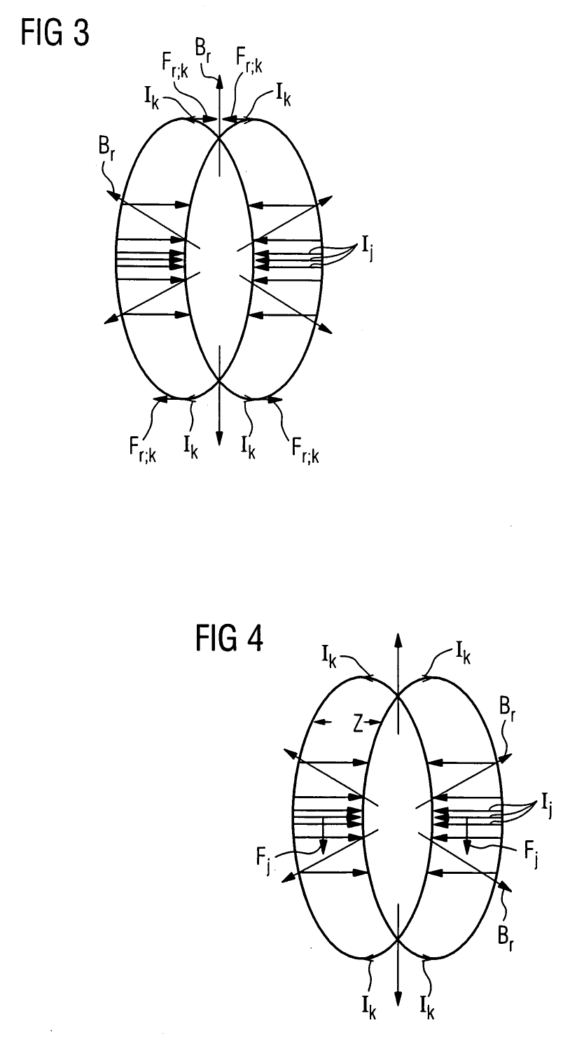

FIG. 2 correspondingly illustrates this. This force F_{z;k} causes a turning moment:

M_{z;k}=F_{z;k}zₖ=πIₖrₖzₖB_{z}

The turning moment M_{r;k} around a transverse axis perpendicular to the gradient direction, originating from the radial secondary component Br(rₖ;zₖ) of the basic magnetic field with regard to the azimuthal currents Iₖ via the transverse force F_{r;k}, is:

$${M}_{z ; k} = {F}_{r ; k} {r}_{k} = {I}_{k} {r}_{k}^{2} {B}_{r} {\int }_{0}^{2 π} {cos}^{2} ϕ ⅆ ϕ = π {I}_{k} {r}_{k}^{2} {B}_{r}$$

FIG. 3 correspondingly illustrates this.

The effective total turning moment M_{azi} of the azimuthal currents Iₖ is thereby:

$${M}_{azi} = π {\sum }_{k} {I}_{k} {r}_{k} ( {r}_{k} {B}_{r} + {z}_{k} {B}_{z} )$$

Given the existence of the radial secondary component Bᵣ of the basic magnetic field, the longitudinal currents Iⱼ likewise generate a transverse force Fⱼ:

$${F}_{j} = - Δ {zB}_{r} {\int }_{0}^{2 π} {sin}^{2} ϕ ⅆ ϕ {\sum }_{j < k} {I}_{j} = - Δ {zB}_{r} {\sum }_{j < k} {I}_{j}$$

FIG. 4 correspondingly illustrates this. Δz is thereby the conductor length forming the basis of the longitudinal current Iⱼ. The transverse force Fⱼ evokes an additional turning moment contribution Mⱼ:

$${M}_{j} = {F}_{j} {z}_{k} = - π {z}_{k} Δ {zB}_{r} {\sum }_{j < k} {I}_{j}$$

In order to compensate against each other the transverse forces F_{r;k} and Fⱼ of the transversal gradient coil, the following expression is to be incorporated as an additional boundary condition in the optimization of the current distribution of the gradient coil:

$${\sum }_{k} ( {I}_{k} {r}_{k} {B}_{z} - Δ {zB}_{r} {\sum }_{j < k} {I}_{j} ) = 0$$

The fundamental bending or flexing vibration mode is excited via the oppositely-directed sum turning moments of both coil halves, meaning via the load of the coil cross section in the plane z=0. To reduce the bending moment, it is necessary to reduce or to eliminate the total turning moment of each coil half. The aforementioned sum turning moment is thus, for example, to be formed over all k of a coil half. An additional boundary condition is thereby to be introduced given the optimization of the gradient coil:

$${\sum }_{k} ( {I}_{k} {r}_{k} ( {r}_{k} {B}_{r} + {z}_{k} {B}_{z} ) - {z}_{k} Δ {zB}_{r} {\sum }_{j < k} {I}_{j} ) = 0$$

The determination of the reference point z=0 with regard to the turning moments M_{z;k} and M_{r;k} is irrelevant when the transverse forces F_{r;k} and Fⱼ are also compensated. Alternatively, it suggests itself to use the focal point of the corresponding coil half, since the magnetic forces in the frequency range of interest are mainly intercepted via inertial forces, and then cause no sum turning moment.

The conductor arrangement of the gradient coil can be clearly determined based on the preceding specifications. In other embodiments, the arrangement of the coils can also be determined via other design methods, for example the design method specified in DE 100 11 034 A1, whereby for this conditions specified in the preceding are correspondingly considered.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1. A magnetic resonance device, comprising:
a basic field magnet to generate a basic magnetic field that exhibits, within an imaging volume of the magnetic resonance device, a main component optimally and exclusively oriented in a predeterminable direction;
at least one gradient coil arranged in a region of a gradient magnetic field in which the basic magnetic field exhibits at least one secondary component perpendicular to the main component; and
conductors of the gradient coil arranged such that, given flow of an electrical current in the conductors, a turning moment operating via the main component and affecting a part of the gradient coil is at least partially compensated by a turning moment acting via the secondary component.

2. The magnetic resonance device according to claim 1 wherein the main component and the secondary component exhibit a comparable magnitude in the region of the conductors.

3. The magnetic resonance device according to claim 1 wherein the conductors are arranged in a substantially hollow cylindrical region.

4. The magnetic resonance device according to claim 3 wherein the main component is oriented in a direction of a hollow-cylinder main axis of the hollow-cylindrical region.

5. The magnetic resonance device according to claim 3 wherein the gradient coil is partitioned into two sub-coils in an axial direction of the hollow-cylindrical region.

6. The magnetic resonance device according to claim 5 wherein a spatial curve of the secondary component in the axial direction in a region of the conductor of one of the sub-coils exhibits a change of sign.

7. The magnetic resonance device according to claim 5 wherein at least one of the sub-coils is designed with regard to its focal point to compensate turning moments.

8. The magnetic resonance device according to claim 5 wherein the conductors of at least one of the sub-coils are arranged such that, given flow of the electrical current in the conductors, forces operating on the conductors perpendicular to the axial direction at least partially counter each other.

9. The magnetic resonance device according to claim 3 wherein the gradient coil comprises a transversal gradient coil.

10. The magnetic resonance device according to claim 1 wherein the gradient coil comprises an actively shielded gradient coil.

11. The magnetic resonance device according to claim 10 wherein the actively shielded gradient coil comprises a primary coil and a shielding coil.

12. A magnetic resonance device, comprising:
a basic field magnet to generate a basic magnetic field that exhibits, within an imaging volume of the magnetic resonance device, a main component oriented in a predeterminable direction;
at least one gradient coil arranged in a region of a gradient magnetic field in which the basic magnetic field exhibits at least one secondary component perpendicular to the main component; and
conductors of the gradient coil arranged such that, given flow of an electrical current in the conductors, a turning moment operating via the main component and affecting at least a part of the gradient coil is at least partially compensated by a turning moment acting via the secondary component.

13. A method for compensating for a turning moment effecting at least a part of a gradient coil in a magnetic resonance device, comprising the steps of:
providing in the magnetic resonance device a basic magnetic field magnet which generates a basic magnetic field that exhibits, within an imaging volume of the magnetic resonance device, a main component oriented in a predeterminable direction;
arranging the gradient coil in a region of a gradient magnetic field in which the basic magnetic field exhibits at least one secondary component perpendicular to the main component; and
arranging conductors of the gradient coil such that, given flow of an electrical current in the conductors, the turning moment caused by the main component and which effects a part of the gradient coil is at least partially compensated by a turning moment acting via the secondary component.
